(19) United States
(12) Patent Application Publication
(10) Pub. No.: US 2023/0312915 A1
(43) Pub. Date: Oct. 5, 2023

(54) PRODUCTION PROCESS OF POLYESTER MICROPOWDERS

(71) Applicant: SOLVAY SPECIALTY POLYMERS USA, LLC, Alpharetta, GA (US)

(72) Inventors: Stéphane Jeol, Saint-Genis-Laval (FR); Kelly D. Branham, Woodstock, GA (US); Benjamin Trotter, Alpharetta, GA (US); Joel Flores, Alpharetta, GA (US); Joel Pollino, Johns Creek, GA (US); Mattia Bassi, Milano (IT)

(73) Assignee: SOLVAY SPECIALTY POLYMERS USA, LLC, Alpharetta, GA (US)

(21) Appl. No.: 17/920,305

(22) PCT Filed: Apr. 19, 2021
(86) PCT No.: PCT/EP2021/060050

§ 371 Date: Oct. 20, 2022

Related U.S. Application Data
(60) Provisional application No. 63/013,005, filed on Apr. 21, 2020.

(30) Foreign Application Priority Data
Jul. 22, 2020 (EP) 20187261.1

(51) Int. Cl. C08L 67/03; C09D 7/65; C09D 167/03

(52) U.S. Cl. CPC C08L 67/03; B29B 9/06; C09D 167/03; C09D 7/65

(57) ABSTRACT

The present invention relates to a process for preparing fine particles of an aromatic copolyester, the process comprising the melt-blending of the aromatic copolyester with a polyester polymer (PE), the cooling the blend and the recovery of the particles by dissolution of the PE into water. The present invention also relates to aromatic copolyester particles obtained therefrom and to the use of these particles in to make coatings or films.

This application claims priority to U.S. provisional patent application No. 63/013,005, filed on 21 Apr. 2020, and to European patent application number 20187261.1, filed on 22 Jul. 2020, the whole content of both applications being incorporated herein by reference for all purposes.

### TECHNICAL FIELD

The present invention relates to a process for preparing fine particles of an aromatic copolyester, the process comprising the melt-blending of the aromatic copolyester with a polyester polymer (PE), the cooling the blend and the recovery of the particles by dissolution of the PE into water. The present invention also relates to aromatic copolyester particles obtained therefrom and to the use of these particles to make coatings or films.

### BACKGROUND ART

Since spherical resin fine particles are excellent in fluidity and adhesion, they are used in various applications such as powder materials for coating, powder materials for producing molded articles, and additives.

There are several methods available to generate small size particle powders. These include traditional techniques such as milling and grinding. In a typical industrial mill, a cylindrical metallic drum containing steel spheres rotates and the spheres inside collide with the material crushing them. The material to be milled can be cooled down making it more brittle and thus easier to crush. Jett mills are capable of producing micron-sized particles. The grinding action of jet mills is created by the multiple jets of high velocity streams of gas. The energy requirement for this process is high and thus favored in production of powders with viable economics. With grinding, the solid particles are formed when the grinding units of the device rub against each other while particles of the solid are trapped in between. Other methods like crushing and cutting are also used for reducing particle sizes, but produce less defined/uniform articles compared to the two previous techniques. Crushing employs hammer-like tools to break the solid into smaller particles by means of impact. A popular example of crushing equipment is a hammer mill which comprises a rotating shaft fitted with freely swinging hammers mounted in a cage. Inside the cage is a breaker plate against which the material collides crushing it into smaller particles. Cutting uses sharp blades to cut the rough solid pieces into smaller ones.

These techniques (milling, grinding, crushing, cutting) are well established and used successfully in various types of materials and applications. However, productions of micron-sized polymer particles/powders via these methods have limited success especially with high performance polymers like copolyesters and copolyamides and the yield decreases as the powder size goes down While particle sizes ranging from few hundreds microns can be prepared, getting to 5 to 50 microns is challenging and may require longer processing and multiple passes making it more expensive with lower yields.

A method for producing spherical liquid crystalline resin fine particles (microspheres) is known, wherein a liquid crystalline resin is melt-mixed with a matrix resin soluble in a solvent, and then the matrix resin is dissolved and removed with a solvent.

For example, JP 2001-064399 provides a process for preparing liquid crystalline polyester microspheres that comprises the melt kneading of a thermoplastic resin composition which has a continuous phase of the thermoplastic resin (A) and a disperse phase of a liquid crystalline polyester (B), then the extruding from a nozzle and the taking-off at a taking-off rate of less than 3.0 times the resin discharge rate to thereby mold it in a strand shape, and the cutting to give it as pellets, or the melt kneading of the thermoplastic resin composition, then the discharging as lumps; then the immersing of the pellets or the lumps in a solvent which dissolves component (A) but does not dissolve component (B), consequently dissolving and removing of component (A). However, also in this case, the polyester particles obtained have an average particle size of about 100 μm.

WO 2019/240153 discloses a similar method including a step of melt-mixing a liquid crystalline resin A and a thermoplastic resin B to obtain a composition C (melt mixing step), and a washing step stirring the obtained composition C in certain solvents dissolving the thermoplastic resin B without dissolving the liquid crystalline resin A. Examples of the solvent used in the washing step include organic solvents such as nitrobenzene, phenol, toluene, methylene chloride, carbon tetrachloride, methyl ethyl ketone, acetone, dimethylformamide, dimethyl sulfoxide, dimethyl sulfone, tetramethyl sulfone, and tetramethylene sulfoxide. One or more organic solvents selected from the following can be used.

Exemplary washing steps are carried out at a temperature ranging from 30° C. to 100° C. for 40 minutes to 80 minutes using a magnetic stirrer or the like. Thereafter, the solution is filtered using a filter or the like to collect insoluble.

However, the use of the organic solvents in the washing requires specific handling, production standards and recycling of the same in an environmentally-friendly way.

More recently, approaches are pursued wherein use of organic solvents is commonly avoided so as to ensure more environmentally-friendly techniques.

The need is thus felt for a process to produce fine particles of aromatic copolyesters wherein use of organic solvents is avoided, so as to ensure more environmentally-friendly techniques which advantageously enable obtaining powders with particle size ideally of about 10 microns.

### SUMMARY OF THE INVENTION

Accordingly, the Applicant faced the problem of providing a process for producing aromatic copolyesters fine particles having high heat resistance, few impurities, and spherical shape without using organic solvents.

The merit of the Applicant has been to identify a class of materials, hereby called polyester polymer (PE), having a thermal stability sufficient to be melt-blend with aromatic copolyesters, which makes possible the preparation of spherical fine particles of aromatic copolyesters that are suitable for co-processing with high temperature aromatic copolyesters. The PE polymer of the present invention withstands high temperatures, that-is-to-say notably does not degrade at high temperatures, for example above 250° C. Additionally, the polyester polymer (PE) is such that it can be dissolved in water, possibly heated to a temperature up to 95° C. The PE polymer of the invention therefore not only presents a thermal stability sufficient to be melt-blended with aromatic copolyesters, but also presents a solubility or dispersibility in water, which makes the overall process for preparing aromatic copolyesters fine particles easy to implement and environmentally friendly.

In a first object, the present invention provides a process for preparing fine particles of aromatic copolyesters, comprising the following steps:
a) melt-blending a mixture (M) comprising:
i) at least one aromatic copolyester (P), and
ii) at least one polyester polymer (PE) comprising units derived from:
at least one dicarboxylic acid component,
at least one diol component, wherein at least 2% by moles of the diol component is a poly(alkylene glycol) having a formula (I):

H(O—CₘH₂ₘ)ₙ—OH

wherein m is an integer from 2 to 4 and n varies from 2 to 10,
b) processing the mixture (M) obtained in step a) into pellets or strands,
c) optionally cooling the pellets or strands obtained in step b) at a temperature below 80° C.,
d) contacting the pellets or strands obtained in step b) or c) with water, possibly heated to a temperature up to 95° C.,
e) recovering fine polymeric particles of the at least one aromatic copolyester (P),
f) optionally drying the particles recovered in step e), and
g) optionally sieving the particles obtained in step e) or in step f).

### BRIEF DESCRIPTION OF THE DRAWINGS

FIG. 1 is a scanning electron microscopy (SEM) image of the particles of LCP.

FIG. 2 is a scanning electron microscopy (SEM) image of the particles of Example 1.

FIG. 3 is a scanning electron microscopy (SEM) image of the particles of Example 2.

FIG. 4 is a scanning electron microscopy (SEM) image of the particles of Example 3.

FIG. 5 is a scanning electron microscopy (SEM) image of the particles of Example 4.

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

The term “percent by weight” (wt % or % by weight, hereinafter) indicates the content of a specific component in a mixture, calculated as the ratio between the weight of the component and the total weight of the mixture.

As used herein, Tm, Tg, and Tc refer to, respectively, melting temperature, glass transition temperature and crystallization temperature. Tm, Tg and Tc can be measured using differential scanning calorimetry (“DSC”) according to ISO-11357-3.

Unless specifically limited otherwise, the term “alkyl”, as well as derivative terms such as “alkoxy”, “acyl” and “alkylthio”, as used herein, include within their scope straight chain, branched chain and cyclic moieties.

Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

Similarly, unless specifically limited otherwise, the term “aryl” refers to a phenyl, indanyl or naphthyl group. The aryl group may comprise one or more alkyl groups, and are called sometimes in this case “alkylaryl”; for example may be composed of an aromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

The process of the present invention is based on the melt-blending of at least one aromatic copolyester (P) with a water-soluble or water dispersible polyester (PE), in such a way as to create fine particles of aromatic copolyester dispersed in a phase made of the water-soluble or water-dispersible polyester (PE), for example by applying a mixing energy sufficient to create discrete particles. The blend is then cooled down and the particles are recovered by dissolution or dispersion of the polyester (PE) in water, possibly heated to a temperature up to 95° C.

More generally, step a) consisting in melt-blending the mixture (M), can take place with any suitable device, such as endless screw mixers or stirrer mixers, for example compounder, compatible with the temperature needed to melt the aromatic copolyester (P). The amount of energy applied to this step may be adjusted so as to control the size of the polymeric particles obtained therefrom. The skilled person in the art can adjust the equipment (e.g. screw geometry) and the parameters of the equipment (e.g. rotation speed) to obtain particles of the desired size, for example with an average diameter varying between about at least 1 μm and about 500 μm.

According to a preferred embodiment, step a) takes place at a temperature above 300° C., for example above 310° C., for example above 320° C., above 330° C.

Step b), consisting in processing the mixture into pellets or strands, can be carried out by a process of extrusion through a die. Step b) preferably take place in an extruder equipped with an extrusion die.

The pellets or strands obtained in step b) may be directly placed in water to dissolve the polyester PE and recover the aromatic copolyester (P) fine particles. Alternatively, the pellets or strands obtained in step b) may be cooled in step c), which is conducted by any appropriate means, at a temperature lower than 80° C., for example lower than 50° C. Mention can notably be made of air cooling or quenching in a liquid, for example in water.

Step d) of contacting the pellets or strands with water may consist in a step of immersing the same into water, possibly multiple baths of water, for example heated to a temperature up to 95° C. This step allows dissolution of the polyester (PE) so as to recover the aromatic copolyester (P) fine particles.

Water to be used in step d) can be supplemented with an acid or a base, for example selected from the group consisting of potassium hydroxide, sodium hydroxide, lithium hydroxide, potassium carbonate, sodium carbonate, lithium carbonate, organic amines, hydrochloric acid and sulphuric acid. This step allows dissolution or dispersion of the polyester so as to recover the polymeric particles.

In step e), recovery of the at least one aromatic copolyester (P) fine particles involves the steps of washing the particles with fresh water until they are suitably free from residual polyester (PE), and sufficient purity is obtained.

The present invention advantageously makes use of neutral pH water or running water.

The steps of the process of the present invention can be carried out batch-wise or continuously.

According to an embodiment, steps c) and d) can be carried out simultaneously in the same equipment.

The process of the invention may also comprise an additional step e) of drying of the particles, and/or an additional step f) of sieving the particles. The step of drying can for example take place in a fluidized bed.

By the term “aromatic copolyester” it is hereby intended to denote a wholly aromatic polyester that is the reaction product of at least one aromatic polyol and at least one aromatic dicarboxylic acid.

Preferably, the aromatic copolyester is an aromatic copolyester further including at least an aromatic hydroxycarboxylic acid as a constituent.

The at least one aromatic copolyester (P) is preferably a liquid crystalline polymer (LCP).

In some embodiments, the aromatic polyol is represented by a formula selected from the following group of formulae:

HO—Ar₁—OH (1),

and

HO—Ar₂-T₁-Ar₃—OH (2),

wherein, Ar₁ to Ar₃ are independently selected C₆-C₃₀ aryl groups, optionally substituted with one or more substituents selected from the group consisting of halogen, a C₁-C₁₅ alkyl, and a C₆-C₁₅ aryl; and T₁ is selected from the group consisting of a bond, O, S, —SO₂—, —C(═O)—, and a C₁-C₁₅ akyl.

In some embodiments, the aromatic diol is preferably selected from the group consisting of 1,3-dihydroxybenzene, 1,4-dihydroxybenzene, 2,5-biphenyldiol, 4,4′-biphenol, 4,4′-(propane-2,2-diyl)diphenol, 4,4′-(ethane-1,2-diyl)diphenol, 4,4′-methylenediphenol, bis(4-hydroxyphenyl)methanone, 4,4′-oxydiphenol, 4,4′-sulfonyldiphenol, 4,4′-thiodiphenol, naphthalene-2,6-diol, and naphthalene-1,5-diol. Preferably, the aromatic diol is 4,4′-biphenol.

In some embodiments, the at least one aromatic dicarboxylic acid is independently represented by a formula selected from the following group of formulae:

HOOC—Ar₁—COOH (3),

and

HOOC—Ar₂-T₂-Ar₃—COOH (4),

wherein Ar₁ to Ar₃ are given as above and are independently selected; and T₂ is selected from the group consisting of a bond, O and S.

In some embodiments, the at least one aromatic dicarboxylic acid is selected from the group consisting of terephthalic acid, isophthalic acid, 4,4′-biphenyldicarboxylic acid, 4,4′-oxydibenzoic acid, 4,4′-(ethylenedioxy)dibenzoic acid, 4,4′-sulfanediyldibenzoic acid, naphthalene-2,6-dicarboxylic acid, naphthalene-1,4-dicarboxylic acid, naphthalene-1,5-dicarboxylic acid, and naphthalene-2,3-dicarboxylic acid.

Preferably the at least one aromatic dicarboxylic acids is selected from the group consisting of terephthalic acid, isophthalic acid, naphthalene-2,6-dicarboxylic acid, naphthalene-1,4-dicarboxylic acid, naphthalene-1,5-dicarboxylic acid, and naphthalene-2,3-dicarboxylic acid.

More preferably, the at least one aromatic dicarboxylic acid is terephthalic acid or isophthalic acid.

Still more preferably, the aromatic copolyester (P) is the reaction product of at least one aromatic polyol as above defined, terephthalic acid and isophthalic acid.

In some embodiments, the aromatic hydroxycarboxylic acid is represented by a formula selected from the group consisting of

HO—Ar₁—COOH (5),

and

HO—Ar₂—Ar₃—COOH (6),

wherein Ar₁ to Ar₃ are given above and are independently selected.

In some embodiments, the aromatic hydroxycarboxylic acid is selected from the group consisting of 4-hydroxybenzoic acid, 3-hydroxybenzoic acid, 6-hydroxy-2-naphthoic acid, 6-hydroxy-1-naphthoic acid, 2-hydroxy-1-naphthoic acid, 3-hydroxy-2-naphthoic acid, 1-hydroxy-2-naphthoic acid, 5-hydroxy-1-naphthoic acid, and 4′-hydroxy-[1,1′-biphenyl]-4-carboxylic acid.

Preferably, the aromatic hydroxycarboxylic acid is selected from the group consisting of 4-hydroxybenzoic acid, 6-hydroxy-2-naphthoic acid, 6-hydroxy-1-naphthoic acid, 2-hydroxy-1-naphthoic acid, 3-hydroxy-2-naphthoic acid, 1-hydroxy-2-naphthoic acid, and 5-hydroxy-1-naphthoic acid. Most preferably, the aromatic hydroxycarboxylic acid are 4-hydroxybenzoic acid and 6-hydroxy-2-naphthoic acid.

In some embodiments, the aromatic copolyesters (P) formed by reaction of the aforementioned monomers has recurring units R_{LCP1} to R_{LCP4}.

Recurring unit R_{LCP1} is represented by the following formula:

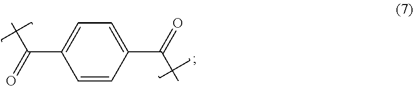

recurring units R_{LCP2} is represented by either one of the following formulae:

-[—O—Ar₁—O—]- (8),

and

-[—O—Ar₂-T₁-Ar₃—O—]- (9);

recurring unit R_{LCP3} is represented by either one of the following formulae:

-[—OC—Ar₁—CO—]- (10),

and

-[—OC—Ar₂-T₂-Ar₃—CO—]- (11)

recurring unit R_{LCP4} is represented by either one of the following formulae:

-[—O—Ar₁—CO—]- (12),

and

-[—O—Ar₂—Ar₃—CO—]- (13).

wherein Ar to Ar₃, T₁ and T₂ are given above and are independently selected.

The person of ordinary skill in the art will recognize that R_{LCP1} according to formulae (7) is formed from terephthalic acid; R_{LCP2} according to formulae (8) and (9) are respectively formed from monomers according to formulae (1) and (2); R_{LCP3} according to formulae (10) and (11) are respectively formed from monomers according to formulae (3) and (4); and R_{LCP4} according to formulae (12) and (13) are formed from monomers according to formulae (5) and (6).

As such, the selection of Ar₁ to Ar₃, T₁ and T₂ for the monomers in formulae (1) to (6) also selects Ar₁ to Ar₃, T₁ and T₂ for recurring units R_{LCP2} to R_{LCP4}. Preferably, recurring units R_{LCP1} to R_{LCP4} are respectively formed from the polycondensation of terephthalic acid, 4,4′-biphenol, isophthalic acid, and 4-hydroxybenzoic acid.

In some embodiments, the total concentration of recurring units R_{LCP1} to R_{LCP4} is at least 50% by moles, at least 60% by moles, at least 70% by moles, at least 80% by moles, at least 90% by moles, at least 95% by moles, at least 99% by moles, or at least 99.9% by moles. In some embodiments, the concentration of the terephthalic acid is from 5% by moles to 30% by moles, preferably from 10% by moles to 20% by moles.

In some embodiments, the concentration of the aromatic diol is from 10% by moles to 30% by moles, preferably from 15% by moles to 25% by moles.

In some embodiments, the concentration of the at least one aromatic dicarboxylic acid is from 1% by moles to 20% by moles, preferably from 1% by moles to 10% by moles.

In some embodiments, the concentration of the aromatic hydroxycarboxylic acid is from 35% by moles to 80% by moles, preferably from 45% by moles to 75% by moles, most preferably from 50% by moles to 70% by moles.

In one embodiment, the R_{LCP1} to R_{LCP4} are, respectively, derived from terephthalic acid, 4,4′-biphenol, isophthalic acid and 4-hydroxybenzoic acid, where the concentration ranges for each recurring unit are within the ranges given above.

In another embodiment, the R_{LCP1} to R_{LCP4} are, respectively, derived from terephthalic acid, 4,4′-biphenol, isophthalic acid and 6-hydroxy-2-naphthoic acid, where the concentration ranges for each recurring unit are within the ranges given above.

As used herein, % by moles is relative to the total number of recurring units in the polymer, unless explicitly indicated otherwise.

For clarity, “derived from” refers the recurring unit formed from polycondensation of the recited monomer, for example, as described above with respect to the relationship between formulae 1 to 6 and 8 to 13.

In a preferred embodiment according to the present invention, the aromatic copolyester (P) is the reaction product of at least one aromatic polyol, terephthalic acid, isophthalic acid and 4-hydroxybenzoic acid.

In some embodiments, the aromatic copolyester (P) has a Tm of at least 220° C., at least 250° C., or at least 280° C.

In some embodiments, the aromatic copolyester (P) has a Tm of no more than 420° C., no more than 390° C., or no more than 360° C.

In some embodiments, the aromatic copolyester (P) has a Tm of from 220° C. to 420° C., from 250° C. to 390° C., or from 280° C. to 360° C.

In some embodiments, the aromatic copolyester (P) has a number average molecular weight (“Mn”) of at least 5,000 g/mol.

In some embodiments, the aromatic copolyester (P) has an Mn of no more than 20,000 g/mol.

In some embodiments, the aromatic copolyester (P) has an Mn of from 5,000 g/mol to 20,000 g/mol.

The number average molecular weight Mn can be determined by gel permeation chromatography (GPC) according to ASTM D5296 and using hexafluoroisopropanol solvent and broad molecular weight semi-aromatic polyamide as a reference standard.

The aromatic copolyester (P) described herein can be prepared by any conventional method.

According to an embodiment, the aromatic copolyester (P) is present in the mixture (M) is an amount of less than 70% by weight, less than 60% by weight, less than 50% by weight, less than 45% by weight, less than 40% by weight, less than 35% by weight, less than 30% by weight, less than 25% by weight or less than 20% by weight, based on the total weight of the mixture (M).

According to the present invention, a “polyester polymer (PE)” denotes any water-soluble or water-dispersible polymer comprising units from:
at least one dicarboxylic acid component,
at least one diol component, wherein at least 2% by moles of the diol component is a poly(alkylene glycol) of formula (1):

H(O—CₘH₂ₘ)ₙ—OH

wherein m is an integer from 2 to 4 and n varies from 2 to 10.

According to an embodiment, the dicarboxylic acid component of the polyester polymer (PE) comprises at least one aromatic dicarboxylic acid, for example selected from the group consisting of isophthalic acid (IPA), terephthalic acid (TPA), naphthalenedicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, and mixtures thereof.

According to an embodiment, the diol component is such that at least 2% by moles of the diol component is a poly(ethylene glycol) of formula (II):

H(O—CH₂—CH₂)ₙ—OH

wherein n varies from 2 to 10.

According to an embodiment, the diol component is such that at least 4% by moles, at least 10% by moles, at least 20% by moles, at least 30% by moles, at least 40% by moles or at least 50% by moles of the diol component (based on the total number of moles of the diol component) is a poly(alkylene glycol) of formula (1):

H(O—CₘH₂ₘ)ₙ—OH

wherein m is an integer from 2 to 4 and n varies from 2 to 10, preferably a poly(ethylene glycol) of formula (11):

H(O—CH₂—CH₂)ₙ—OH

wherein n varies from 2 to 10.

According to another embodiment, the diol component is such that at least 2% by moles, at least 4% by moles, at least 10% by moles, at least 20% by moles, at least 30% by moles, at least 40% by moles or at least 50% by moles of the diol component (based on the total number of moles of the diol component), is a diethylene glycol of formula HO—CH₂—CH₂—O—CH₂—CH₂—OH.

According to a further embodiment, apart from the 2% by moles minimal content of poly(alkylene glycol), the diol component may comprise at least one diol selected from the group consisting of ethylene glycol, 1,4-cyclohexanedimethanol, propane-1,2-diol, 2,2-dimethyl-1,3-propanediol, 1,3-propanediol, 1,4-butanediol, 1,5-pentanediol, 1,6-hexanediol, 2-methyl-1,5-pentanediol, isosorbide and 2,5-bishydroxymethyltetrahydrofuran.

According to yet another embodiment, the diol component of the polyester polymer (PE) consists essentially in:
a diol selected from the group consisting of ethylene glycol, 1,4-cyclohexanedimethanol, propane-1,2-diol, 2,2-dimethyl-1,3-propanediol, 1,3-propanediol, 1,4-butanediol, 1,5-pentanediol, 1,6-hexanediol, 2-methyl-1,5-pentanediol, isosorbide and 2,5-bishydroxymethyltetrahydrofuran,
at least 2% by moles of poly(ethylene glycol) having a formula (II):

H(O—CH₂—CH₂)ₙ—OH

wherein n varies from 2 to 10.

According to another embodiment, the diol component of the polyester polymer (PE) consists essentially in:
a diol selected from the group consisting of ethylene glycol, 1,4-cyclohexanedimethanol, propane-1,2-diol, 2,2-dimethyl-1,3-propanediol, 1,3-propanediol, 1,4-butanediol, 1,5-pentanediol, 1,6-hexanediol, 2-methyl-1,5-pentanediol, isosorbide and 2,5-bishydroxymethyltetrahydrofuran,
at least 2% by moles of diethylene glycol (based on the total number of diol components).

According to the present invention, preferred polyester (PE) are polyesters which further comprise recurring units from a difunctional monomer containing at least one SO₃M group attached to an aromatic nucleus, wherein the functional groups are carboxy and wherein M is H or a metal ion selected from the group consisting of sodium, potassium, calcium, lithium, magnesium, silver, aluminium, zinc, nickel, copper, palladium, iron, and cesium, preferably from the group consisting of sodium, lithium and potassium. Such preferred polyester are sometimes called sulfopolyester (SPE). According to this embodiment, the difunctional sulfomonomer can for example be present in the SPE in a molar ratio comprised between 1 to 40% by moles, based on the total number of moles (i.e. total number of moles of diacid and diol components if the SPE is composed exclusively of diacid and diol components) in the SPE, for example between 5 and 35% by moles, or between 8 to 30% by moles.

According to an embodiment of the present invention, the polyester (PE) comprises units from:
at least one dicarboxylic acid component,
at least one diol component, wherein at least 2% by moles of the diol component is a poly(alkylene glycol) of formula (1):

H(O—CₘH₂ₘ)ₙ—OH

wherein m is an integer from 2 to 4 and n varies from 2 to 10,
at least one difunctional monomer containing at least one SO₃M group attached to an aromatic nucleus, wherein the functional groups are carboxy and wherein M is H or a metal ion selected from the group consisting of sodium, lithium and potassium

According to another embodiment of the present invention, the polyester (PE) comprises units from:
at least one aromatic dicarboxylic acid component,
at least one diol component,
at least 1% by moles (based on the total number of units moles in the PE, e.g. total number of diacid and diol components if the PE is composed exclusively of diacid and diol units) of poly(alkylene glycol) of formula (1):

H(O—CₘH₂ₘ)ₙ—OH

wherein m is an integer from 2 to 4 and n varies from 2 to 10, preferably m equals 2 and n equals 2,
at least one aromatic dicarboxylic acid containing at least one SO₃M group attached to an aromatic nucleus, wherein M is H or a metal ion selected from the group consisting of sodium, lithium and potassium.

According to a preferred embodiment of the present invention, the polyester (PE) comprises or consists essentially in units from:
an aromatic dicarboxylic acid selected from the group consisting of isophthalic acid (IPA), terephthalic acid (TPA), naphthalendicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene and mixture thereof, preferably isophthalic acid,
a diol selected from the group consisting of ethylene glycol, 1,4-cyclohexanedimethanol, propane-1,2-diol, 2,2-dimethyl-1,3-propanediol and mixture thereof,
at least 1% by moles (based on the total number of units moles in the PE, e.g. total number of diacid and diol components if the PE is composed exclusively of diacid and diol units) of diethylene glycol,
an aromatic dicarboxylic acid (e.g. isophthalic acid, terephthalic acid, 2,6-naphthalene dicarboxylic acid) containing at least one SO₃M group attached to an aromatic nucleus, wherein M is H or a metal ion selected from the group consisting of sodium, lithium and potassium

According to an embodiment, the PE comprises at least 2% by moles, at least 4% by moles, at least 10% by moles, at least 20% by moles, at least 30% by moles, at least 40% by moles or at least 50% by moles of diethylene glycol, based on the total number of units moles in the PE, e.g. total number of diacid and diol components if the PE is composed exclusively of diacid and diol units.

Illustrative of such polyesters are Eastman AQ Polymers, especially those having a glass transition temperature ranging from about 25° C. to about 50° C. Most preferred is Eastman AQ 38S which is a polyester composed of diethylene glycol, cyclohexanedimethanol (CHDM), isophthalates and sulfoisophthalates units.

The polyester (PE) of the present invention may be in the form of a salt of sulfonic acid or/and carboxylic acid, more precisely a sulfonate —SO₃ or a carboxylate —COO⁻. The PE may therefore comprise one or several groups (SO₃⁻M⁺) and/or (COO⁻M⁺), in which M is a metal. According to an embodiment, M is selected from the group consisting of sodium, potassium or lithium, calcium, magnesium, silver, aluminium, zinc, nickel, copper, palladium, iron and cesium.

The polyesters (PE) of the present invention can for example be derived through esterification of the mentioned components.

The number average molecular weight of the polyesters (PE) may be between 1,000 g/mol and 40,000 g/mol, more preferentially between 2,000 g/mol and 30,000 g/mol, as determined by GPC.

According to an embodiment, the polyester (PE) polymer is present in the mixture (M) in an amount of at least 30% by weight, at least 35% by weight, at least 40% by weight, at least 45% by weight, at least 45% by weight, at least 50% by weight, at least 55% by weight, at least 60% by weight, at least 65% by weight, at least 70% by weight, at least 75% by weight or at least 80% by weight, based on the total weight of the mixture (M).

According to a preferred embodiment, the mixture (M) comprises:
a) from 20 to 60% by weight of aromatic copolyester (P), and
b) from 40 to 80% by weight of polyester (PE).

The Applicant has surprisingly found that the process of the invention allows easily obtaining fine particles of the aromatic copolyesters (P) characterized by having a small amount of impurities and regular shape and size at a low cost.

As used herein, the term “particle” refers to an individualized entity.

By the term “fine particle” it is hereby intended to denote a particle having a particle size distribution D50 (in short “D50”) of about 0.1 μm to 100 μm, wherein D50 is also known as the median diameter or the medium value of the particle size distribution, according to which 50% of the particles in the sample are larger and 50% of the particles in the sample are smaller.

Particle Size Analysis can for example take place in a Microtrac™ S3500 with Microtrac Sample Delivery Controller (SDC).

The D50 of the aromatic copolyesters (P) fine particles is preferably from 0.5 μm to 50 μm, more preferably from 1 μm to 25 μm, further preferably from 1 μm to 10 μm.

The particles of the present invention are preferably substantially spherical, for example with a circularity and/or a roundness of at least 0.75, for example at least 0.8 or at least 0.85.

The roundness is defined as a measure of surface smoothness of the particles and is measured according to the following equation:

[symbol]

The circularity is defined as the measure of spherical shape of the particles and is measured according to the following equation:

[symbol]

The aromatic copolyester (P) fine particles obtained by the process of the present invention are suitably substantially free from impurities, in particular substantially free from residual polyester (PE).

The content of residual polyester PE component in the aromatic copolyester (P) fine particles may be evaluated by thermogravimetric analysis.

The term “suitably free from residual polyester (PE)” means that the content of residual polyester PE in the aromatic copolyester (P) fine particles is

preferably less than 0.1% by weight, more preferably less than 0.05% by weight, still more preferably, the content is less than 0.01% by weight. or less.

The Applicant has surprisingly found that the process of the invention allows easily obtaining fine particles of the aromatic copolyesters (P) starting from aromatic polyesters of bigger particle size with a very limited impairment of the melt viscosity of the same, not more than 30% in comparison with the melt viscosity of the particle before the process of converting the particles into fine particles.

The particles of the present invention can be characterized by their bulk density and by their tapped density. The bulk density of a powder is the ratio of the mass of an untapped powder sample and its volume including the contribution of the interparticulate void volume. The bulk density can be expressed in grams per millilitre (g/ml) or in grams per cubic centimetre (g/cm³). Density measurements can for example take place in a Quantachrome Autotap™ Tapped Density analyser.

The particles of aromatic copolyester (P) obtained from the process above-described can also be submitted to at least one of the following possible steps:
drying to a temperature of at least 80° C., for example at least 90° C., for at least 0.5 hour, preferably at least an hour, at possibly reduced pressure;
   and
sieving.

In another aspect, the present invention provides fine particles of aromatic copolyester (P) obtainable by the process as above defined.

The fine particles of aromatic copolymers (P) of the present invention can be used in various applications, notably as additive in varnish formulations such as polyimides, polyimide precursors or epoxy to make coatings and films with low target thickness, in the range of 5 to 100 microns.

The present invention will be now described in more detail with reference to the following examples, whose purpose is merely illustrative and not limitative of the scope of the invention.

### EXAMPLES

### Raw Materials

PE: Sulfopolyester Eastman AQ™ 48 commercially available from Eastman. This PE is composed of diethylene glycol, cyclohexanedimethanol (CHDM), isophthalates and sulfoisophthalates units. According to 1H NMR analysis, the molar concentration of diethylene glycol of 70% by moles, based on the total moles of diols (CHMD+diethylene glycol).

PCT: poly (cyclohexylenedimethylene terepthtalate), commercially available from Eastman

### Preparative Example 1: Synthesis of LCP

To synthesize the LCP, the dicarboxylic acid monomers terephthalic acid (167.0 g, Flint Hills Resources), isophthalic acid (55.7 g, Lotte Chemicals), p-hydroxybenzoic acid (555.5 g, Sanfu), 4,4′-biphenol (201.6 g, SI Group) and acetic anhydride (769.2 g, Aldrich)) were charged into a 2-L glass reactor. Potassium acetate (0.07 g, Aldrich) and magnesium acetate (0.2 g, Aldrich) were used as catalysts. The mixture was heated to 165° C. and the acetylation reaction under reflux condition was allowed to proceed for 1 hr. The heating then continued to 300° C. at the rate of 0.5° C. per minute while distilling off acetic acid from the reactor. The pre-polymer was discharged and allowed to cool down. The material was then ground into powder for solid-state polymerization. The resin was advanced in a rotatory oven using the following profile: 1 hr at 220° C., 1 hr at 290° C. and 12 hrs at 310° C. under continuous nitrogen purging. The resulting high molecular resin had melt viscosity between 500-1500 poise at 370 C and 100 per s shear rate

Material Processing

Mixtures were made according to Table 1.

Each composition was melt-blended in a ZSK26 twin-screw extruder at a temperature in the range 330-360° C. and at 100-200 rpm. Each mixture was then processed into strands and then quenched in air until solid. Samples were immersed into water heated to 95° C., for 2 hours. Water was then removed. Samples were immersed again into water heated at 90° C., for 2 hours.

Some compositions (Ex 1 and Ex 2) gave a polymer powder according to the invention. The powders were then isolated by filtration, washed with water and vacuum dried.

TABLE 1

| | LCP | PE | PCT |
|---|---|---|---|
| | (% by weight) | (% by weight) | (% by weight) |
| Ex 1 | 40 | 60 | — |
| Ex 2 | 30 | 70 | — |
| Ex 3 C | — | 60 | 40 |
| Ex 4 C | — | 70 | 30 |

Scanning Electron Microscopy (SEM)

Scanning electron microscopy was used to examine each polymer sample as indicated below. Powders were dispersed onto carbon-tape affixed to aluminum stub, and then sputter-coated with AuPd using an Emitech K575x Turbo Sputter Coater. Images were recorded using a Hitachi S-4300 Cold Field Emission Scanning Electron Microscope and images were analysed for average diameter using ImageJ v 1.49b Java-Based Image Analysis Software on approximated 50 particle images. A summary of average particle diameter estimated from SEM pictures for the powders appear in Table 2.

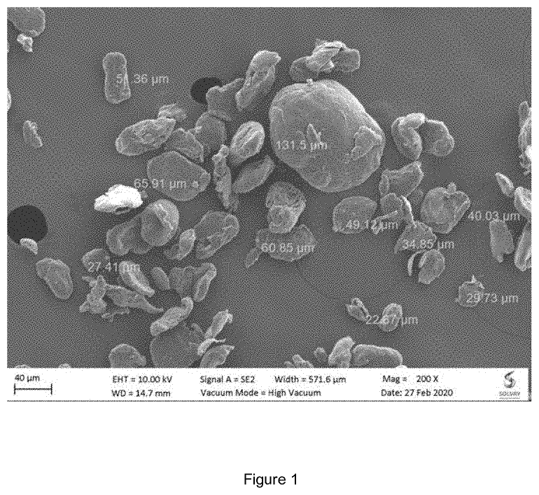

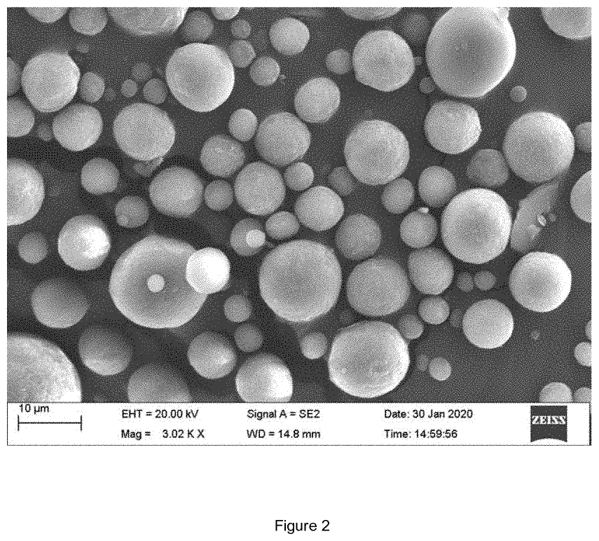

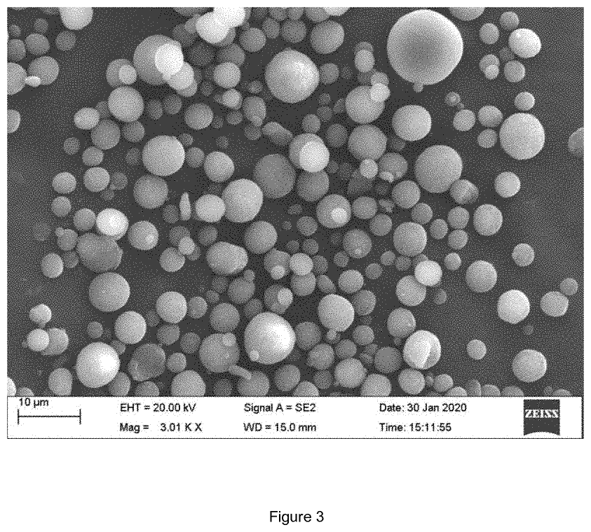

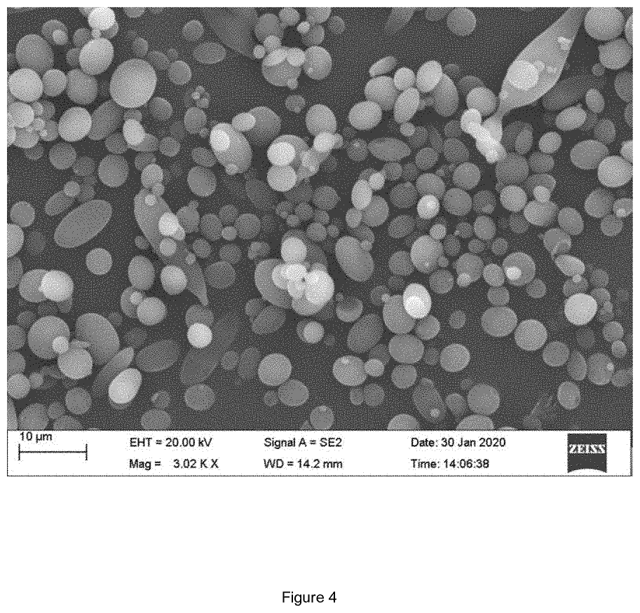

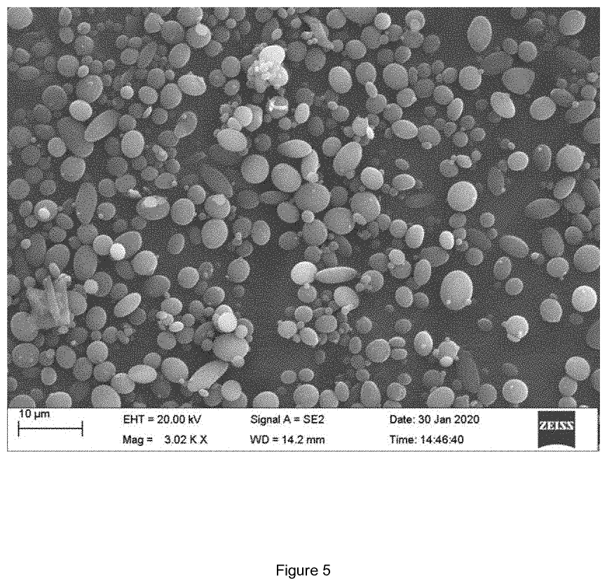

FIG. 1 is the SEM scan of the LCP starting particles, FIGS. 2 and 3 are the SEM scan of the LCP particles of Examples 1 and 2 and FIG. 4 and FIG. 5 are the SEM scan of the PCT particles of Comparative Examples 3 and 4. Powders according to the invention have more homogeneous spherical shape whereas those obtained by processing PCT have disk-like and more elongated shape particles.

TABLE 2

| | Average particle |
|---|---|
| | Particle size by |
| | microscopy |
| | (μm) |
| Ex 1 | <12 |
| Ex 2 | <10 |
| Ex 3 C | <10 |
| Ex 4 C | <12 |

Melt Viscosity Measurements

The powders were dried at 150° C. for 10 minutes and at 120° C. for 5 minutes prior to melt viscosity measurement. The melt viscosity at 100 per s shear rate was determined using capillary rheometer (Dynisco LCR 7000, die L/D=20) set at test temperature indicated in Table 3.

Results are shown in Table 3.

Density Measurements

Density measurements were carried out in a Quantachrome Autotap™ Tapped Density analyser. Results are shown in Table 3.

Residual PE in Fine Particles

By thermogravimetric analysis in temperature scanning mode (30-8000 under nitrogen atmosphere, the quantity of residual PE in powders was calculated. Results are shown in Table 3.

TABLE 3

| | Melt viscosity | | | | | |
|---|---|---|---|---|---|---|
| | (poise) | | | | | |
| | Test | Shear | | | | |
| | Temper- | rate | DSC | Residual | Bulk | Tapped |
| | ature | (per sec) | Tm2 | PE | density | density |
| | (° C.) | 100 | (C) | % | g/cm3 | g/cm3 |
| LCP* | 370 | 959 | 350-370 | — | 0.70 | 0.86 |
| Ex 1 | 370 | 671 | 350 | n.d. | 0.84 | 1.01 |
| Ex 2 | 370 | 824 | 351 | n.d | 0.80 | 1.02 |
| PCT* | 310 | 1109 | 285 | — | n-a. | n.a. |
| Ex 3 C | 310 | 117 | 286 | 1.4 | 0.46 | 0.56 |
| Ex 4 C | 310 | 263 | 286 | 1.1 | 0.35 | 0.44 |

*Neat materials, before processing

The results demonstrate that the fine particles of aromatic copolymers of the present invention show a high purity, expressed in terms of residual PE, while the same process applied to semi-aromatic polyester led to particles still having residual PE in their powder.

Surprisingly, it has been discovered that the LCP particles obtained by this process, unlike semi-aromatic PCT particles, are obtained with a diameter lower than 20 micron and with a spherical shape and with a good retention of their initial melt viscosity.

Moreover, the particles of PCT of the comparative examples 3 and 4 show a strong loss of their melt viscosity after processing, meaning that the performance of the PCT particles is significantly degraded. Surprisingly, it has been observed that the LCP particles of Examples 1 and 2 maintain quite well their high melt viscosity after processing, meaning that they do not show any significant loss of their performance.

Should the disclosure of any patents, patent applications, and publications which are incorporated herein by reference conflict with the description of the present application to the extent that it may render a term unclear, the present description shall take precedence.

1. A process for preparing fine particles of aromatic copolyester (P) comprising the following steps:
a) melt-blending a mixture (M) comprising:
i) at least one aromatic copolyester (P), and
ii) at least one polyester polymer (PE) comprising units derived from:
at least one dicarboxylic acid component,
at least one diol component, wherein at least 2% by moles of the diol component is a poly(alkylene glycol) having a formula (I):
H(O—CₘH₂ₘ)ₙ—OH
wherein m is an integer from 2 to 4 and n varies from 2 to 10,
b) processing the mixture (M) obtained in step a) into pellets or strands,
c) optionally cooling the pellets or strands obtained in step b) at a temperature below 80° C.,
d) contacting the pellets or strands obtained in step b) or c) with water,
e) recovering fine polymeric particles of the at least one aromatic copolyester (P),
f) optionally drying the particles recovered in step e), and
g) optionally sieving the particles obtained in step e) or in step f).

2. The process of claim 1, wherein the at least one polyester (PE) is water-soluble or water dispersible.

3. The process of claim 1, wherein the polyester (PE) further comprises recurring units from a difunctional monomer containing at least one SO₃M group attached to an aromatic nucleus, wherein the functional groups are carboxy and wherein M is H or a metal ion selected from the group consisting of sodium, lithium, potassium, and combinations thereof.

4. The process of claim 1, wherein the polyester (PE) comprises units from:
at least one aromatic dicarboxylic acid component,
at least one diol component,
at least 1 mol. % (based on the total number of moles in the PE) of poly(alkylene glycol) of formula (I):
H(O—CₘH₂ₘ)ₙ—OH
wherein m is an integer from 2 to 4 and n varies from 2 to 10,
at least one aromatic dicarboxylic acid containing at least one SO₃M group attached to
an aromatic nucleus, wherein M is H or a metal ion selected from the group consisting of sodium, lithium, potassium, and combinations thereof.

5. The process of claim 1, wherein the polyester (PE) comprises:
isophthalic acid,
a diol selected from the group consisting of ethylene glycol, 1,4-cyclohexanedimethanol, propane-1,2-diol, 2,2-dimethyl-1,3-propanediol, and mixtures thereof,
at least 2% by moles (based on the total number of moles in the PE) of poly(alkylene glycol) of diethylene glycol,
an aromatic dicarboxylic acid containing at least one SO₃M group attached to an aromatic nucleus, wherein M is H or a metal ion selected from the group consisting of sodium, lithium, potassium, and combinations thereof.

6. The process of claim 1, wherein the aromatic copolyester (P) is a wholly aromatic polyester that is the reaction product of at least one aromatic polyol, at least one aromatic dicarboxylic acid and at least an aromatic hydroxycarboxylic acid.

7. The process of claim 1, wherein the aromatic copolyester (P) is a liquid crystalline polymer (LCP).

8. The process of claim 1, wherein the aromatic copolyester (P) is the reaction product of at least one aromatic polyol, terephthalic acid, isophthalic acid and 4-hydroxybenzoic acid.

9. The process of claim 1, wherein the aromatic copolyester (P) is the reaction product of at least one aromatic polyol, terephthalic acid and 6-hydroxy-2-naphthoic acid.

10. The process of claim 1, wherein the mixture (M) comprises:
a) from 20 to 60% by weight of the aromatic copolyester (P), and
b) from 40 to 80% by weight of the polyester (PE).

11. The process of claim 1, wherein the step of melt-blending takes place at a temperature above 300° C.

12. Fine particles of aromatic copolyester (P) obtainable by the process of claim 1.

13. The particles of claim 12, wherein the particles have a D50 comprised between 0.5 μm and 50 μm.

14. A method of making coatings and films, the method comprising adding the particles of claim 12 to varnish formulations to make coatings and films.
